(19) United States
(12) Patent Application Publication
(10) Pub. No.: US 2008/0230483 A1
(43) Pub. Date: Sep. 25, 2008

(54) Disposable organoclay cartridge

(75) Inventor: Jonathan M. Fabri, Johns Island, SC (US)

Correspondence Address: NELSON MULLINS RILEY & SCARBOROUGH, LLP, 1320 MAIN STREET, 17TH FLOOR, COLUMBIA, SC, 29201, US

(73) Assignee: Polymer Ventures, Inc., Charleston, SC (US)

(21) Appl. No.: 11/725,781

(22) Filed: Mar. 20, 2007

(51) Int. Cl. C02F 1/28; B01D 15/04; B01D 27/02; C02F 1/42

(52) U.S. Cl. 210/691; 210/282

(57) ABSTRACT

A disposable cartridge for the removal of contaminant particles having a diameter of less than about 0.5 millimeter from an aqueous stream is provided. The cartridge includes a substantially cylindrical chamber filled with a non-swelling organoclay, and end fittings designed for removable insertion into a flow channel carrying the aqueous stream and which direct the flow of the aqueous stream through the cartridge.

### BACKGROUND OF THE INVENTION

The present invention relates generally to the removal of oil, hydrocarbons, and other organic materials from water. More specifically, the present invention relates to the removal of oil, hydrocarbons, and other organic materials from bilgewater.

Contaminated liquids are commonly produced as a result of industrial activities, transportation over land and water, and storage and handling. Accidental releases, runoff, and the like are common problems that result in oil contaminated water, which is caused by spilling, leaking, or otherwise contacting the water with crude or refined oils, lubricants, fuels, or exhaust. The contaminants can render the liquid hazardous or unsuitable in terms of potability, industrial exposure, appearance, odor, growth of microorganisms, or environmental release. Methods of treating contaminated liquids are known, including the use of certain clays, treated clays, activated carbon, and other materials as absorbents or adsorbents for the contaminants.

Recent changes in environmental regulations, specifically the new Marine Environment Protection Committee (MEPC) bilgewater discharge regulations have created a new need for more effective methods to treat bilgewater. The regulation of shipboard bilgewater stems from Annex I of the International Maritime Organizations (IMO) Conferences of 1973 and 1978 (MARPOL 73/78). Under the IMO, the MEPC periodically drafts resolutions to MARPOL 73/78. Until recently, (Jan. 1, 2005), bilgewater filtering equipment had to meet the minimum requirements as stipulated in MEPC 60(33). The Type Approval test outlined in 60(33) ensured that bilgewater separators were capable of removing dispersed and free oils to <15 ppm before discharge. Many manufacturers of oil/water separator (OWS) equipment, such as coalescers, hydrocyclones, and centrifuges were capable of making 60(33) compliant equipment. It was eventually realized, however, that the bilges of most ships became contaminated with surfactants from firefighting and cleaning compounds that created oily emulsions, which easily passed through the existing mechanical separators. MEPC 107(49) was, therefore, drafted to replace MEPC 60(33).

The new Type Approval test protocol in 107(49), effective Jan. 1, 2005, specifies that the OWS equipment must be certified using three test fluids (A, B, and C). Test Fluid C is the most challenging system because it contains a mixture of Test Fluids A and B, plus a surfactant (DDBSA), which creates a chemically stabilized emulsion. Since the adoption of 107(49) in July 2003, nearly every approved bilgewater OWS manufacturer has added a polishing step to the effluent of their respective mechanical separators. All of these systems then had to be re-certified by the proper authority (US Coast Guard for US Flag ships). Many OWS companies have used complicated/expensive technologies, such as bioreactors and ultrafiltration membranes to make their equipment 107(49) compliant.

Organoclay compositions have been shown to be effective at removing organics from water. In many instances, the organoclay compositions have proven more effective than carbon at removing oil and grease from water.

Naval and commercial vessels generate large volumes of oily wastewater, mostly in the form of bilge water and ballast water. Bilge water typically contains various oils and fuels, grease, antifreeze, hydraulic fluids, cleaning and degreasing solvents, detergents, rags, and metals (including arsenic, copper, cadmium, chromium, lead, nickel, silver, mercury, selenium, and zinc) that collect during the daily operation of a vessel. Bilge water may also contain “gray water,” which includes galley water; turbid water from showers and laundry; and drainage water from air conditioning units, drinking fountains, and deck drains. Ballast water may be contaminated with oil that was transported in the ship prior to ballasting, or may contain small animal and vegetable sea life drawn in with the ballast water.

Other smaller sources of oily wastewater generated onboard ships include steam condensate, boiler blowdown, elevator pit effluent, deck runoff, gas turbine wash water, motor gasoline compensating discharge, and aqueous wastes from other diverse types of machinery and machine operations.

In the past, these oily wastewaters were either stored for subsequent onshore treatment or simply discharged overboard. More recently, regulating bodies such as MARPOL, the EPA, the U.S. Coast Guard, the Department of Defense, and some states have enacted more stringent restrictions on the location and extent of such discharges. These new regulations require oily wastewater to be treated to 15 ppm or less oil content prior to overboard discharge. Some regions have yet more stringent requirements. For example, Canadian regulations in the Great Lakes limit oil content of discharged waters to 5 ppm. Uniform National Discharge Standards (UNDS) for vessels of the armed forces, now being developed in the United States under a three-phase program, may require numerous possible discharge streams to be controlled, and may be expanded to include additional pollutants, such as metals, as well as to civilian shipping.

The current state of the art is to hold wastewater in a storage tank for the duration of the voyage and to treat it later onshore, or to use oil/water separators (OWS) such as hydrocyclones, centrifuges, coalescers, and parallel-plate type, to treat water on the ship. OWS systems are mechanical separators that separate based on the different densities of oil and water phases. Under appropriate conditions, such separators can provide reasonably good separation of discrete oil and water phases. They are ineffective, however, in removing colloidal particles, emulsified oil or dissolved oil, so the mechanical oil/water separators are unable to consistently meet the 15 ppm limit in most cases.

Both storage and simple gravity separation obviously have many drawbacks, and a clear need for better treatment techniques exists.

The U.S. Navy has installed separation systems using ceramic ultrafiltration membranes on a few vessels. When clean, the membrane systems have sufficient separation capability to meet the 15 ppm oil in wastewater discharge requirement. However, they are very susceptible to internal fouling (plugging of pores by oil or other contaminants) and surface fouling (build-up of an oil layer on the surface of the membrane). As a result, the membranes must be taken off-line and back-flushed or otherwise cleaned every day. Cleaning gradually becomes less effective, and the transmembrane water flux may decline to a level at which more water is being generated than can be treated.

Other methods of removing contaminants include filtration devices that trap the contaminants as the bilgewater is passed through them. These filtration devices typically include a radial flow of bilgewater, limiting the time the bilgewater is in contact with the filtration medium, e.g., organoclay. The radial flow devices were typically utilized to allow for overswelling of the organoclay filtration medium.

One additional drawback to the previous filtration devices is that once the devices are saturated with contaminants, they must be stored onboard a ship until the ship reaches port. Those having ordinary skill in the art will recognize that space constraints are a common problem on ships. The more cargo space necessary for storing filtration devices, the less cargo space is available for transporting cargo.

Many companies have added “polishing” filters to older systems. The purpose of the polishing filters is to address emulsified oils in the bilgewater systems. Polishing options include bacterial digestion, polypropylene radial flow filters, modified cellulosic materials, flocculants, ultrafiltration, and bulk granular adsorbent medias. Each of these systems has several drawbacks, making them impracticable for shipboard use. For example, bacteria based systems need long digestion times, have a large footprint, and low flow rates. Accordingly, they are often too large for shipboard use and do not have sufficient treatment times.

The polypropylene radial flow filter system has a limited capacity and requires frequent, time-consuming changeouts. The flocculant systems are complicated, with high sensitivity to oil loading and pH, often requiring further polishing after the initial treatments. The ultrafiltration systems are often fouled by spikes in contaminant concentration and require frequent cleaning. Finally, the previous organoclay systems required vessels that were too large for shipboard use, impractical media changeouts, and disposal concerns.

It would be desirable, therefore, to develop a disposable system for treatment of bilgewater in a shipboard environment that overcomes some or all of the above referenced problems faced in the shipboard environment.

### SUMMARY OF THE INVENTION

Briefly, therefore, the present invention is a method for the removal of contaminant particles having a diameter of less than about 0.5 millimeter from an aqueous stream. The method includes providing a disposable cartridge through which the contaminant-containing aqueous stream can be directed, wherein the cartridge includes a packed bed of non-swelling organoclay, directing the contaminant-containing aqueous stream through the disposable cartridge, and absorbing, adsorbing, coalescing, chelating, and/or associating the contaminant particles onto the non-swelling organoclay.

In another aspect, the invention is a disposable cartridge for the removal of contaminant particles having a diameter of less than about 0.5 millimeter from an aqueous stream. The cartridge includes a substantially cylindrical chamber filled with a non-swelling organoclay, and end fittings designed for removable insertion into a flow channel carrying the aqueous stream and which direct the flow of the aqueous stream through the cartridge.

In yet another aspect, the invention is a method for shipboard decontamination of bilgewater containing oil contaminants. The method includes passing the contaminated bilgewater through a disposable cartridge packed with a non-swelling organoclay having a particle size range of between about 0.1 and about 10 mm. The method further includes adsorption, absorption, and/or coalescence of the contaminants on the non-swelling organoclay. The decontaminated bilgewater then exits the disposable cartridge.

These and other aspects of the invention will be understood and become apparent upon review of the specification by those having ordinary skill in the art.

### BRIEF DESCRIPTION OF THE DRAWINGS

FIG. 1 is a schematic representation of an axial flow disposable cartridge in accordance with the present invention.

FIG. 2 is a schematic representation of a radial flow disposable cartridge in accordance with the present invention.

### DETAILED DESCRIPTION OF SEVERAL EMBODIMENTS

Reference now will be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention covers such modifications and variations as come within the scope of the appended claims and their equivalents. Other objects, features and aspects of the present invention are disclosed in or are obvious from the following detailed description. It is to be understood by one of ordinary skill in the art that the present discussion is a description of exemplary embodiments only, and is not intended as limiting the broader aspects of the present invention.

In one aspect, the present invention is a disposable cartridge for the removal of contaminant particles having a diameter of less than about 0.5 millimeter from an aqueous stream. As used herein, the term “contaminant particles” shall be understood to encompass all contaminants in a water supply. Such contaminant particles include, but are not limited to oil, grease, hydrocarbons, pesticides, heavy metals, radioactive waste, colored materials, odor-causing materials, suspended solids, turbidity, haze, paint, solvents, resins, condensate, industrial effluent, deinking waste, surfactants, emulsified materials, microorganisms, MTBE, BTEX, BOD, COD, and combinations thereof. For ease of discussion, the invention will be described in terms relating to the removal of oil. Those having ordinary skill in the art will recognize that such terminology is for ease of discussion only, and shall not be limiting on the methods or apparatuses discussed herein. Stated differently, as used herein, and unless explicitly stated otherwise, references to “oil” shall be interpreted as including all contaminant particles described herein. Similarly, the term “particles” shall include droplets, emulsions, micro-emulsions, and dispersions. Absorption of dissolved contaminants are also contemplated in the present method and apparatus.

In one embodiment, the invention includes a disposable cartridge through which an oil-containing aqueous stream can be directed. The disposable cartridge may be any geometric shape. In some embodiments, it may be preferred that the cartridge be substantially cylindrical. In an exemplary embodiment, the disposable cartridge is constructed of a plastic material, such as a thermoplastic or thermoset plastic, that is capable of being incinerated. The preferred plastic is stable to salt water exposure in a temperature range of from about 5° C. to about 95° C. Exemplary plastics contemplated as useful for construction of the present disposable cartridges include one or more of polyarylether-ether ketone, polybutene-1, polyamides, polycarbonates, polyethylene terephthalate, polybutylene terephthalate, polyphenylene sulfide, polypropylene, polyvinyl chloride, thermoplastic elastomers, acrylonitrile-butadiene-styrene, cellulosics (including CA, CAB, CAP, and CN), styrene acrylonitrile, acrylonitrile styrene acrylate, ethylene vinyl acetate, polytetrafluoroethylene, polyacetals, high density polyethylene, low density polyethylene (LDPE or LLDPE), polymethylpentene, polyphenylene oxide, polystyrene (general purpose polystyrene or high impact polystyrene), unsaturated polyesters, alkyds, allylics, epoxies, furan, melamine and urea resins, phenolics, polyurethanes, and vinyl esters.

In yet another exemplary embodiment, the disposable cartridge meets OSHA or other government and corporate guidelines regarding weight limitations for lifting by a single person. For example, in one embodiment, the disposable cartridge is preferably less than about 50 pounds. In yet another embodiment, the disposable cartridge is preferably between about 30 and 50 pounds when packed with a non-swelling organoclay.

The disposable cartridge suitable for use in the present method is preferably between about 8 and about 72 inches in length and between about 2 and about 12 inches in diameter. In some embodiments, the cartridge may be sized for use in commonly available filter housings. Those having ordinary skill in the art will recognize the commonly available filter housings. In an exemplary embodiment, the disposable cartridge is sized for use in a #2 bag filter housing. Those having ordinary skill in the art will recognize that the use of such housings is widespread in the industry for the removal of suspended solids from waste streams. Filter bags or “socks” are constructed in a variety of materials having a range (micron/mesh) of perforated openings. Disposable cartridges in accordance with the present invention may be constructed to fit any filter housing known in the art, thereby reducing the need for redesign or custom design of equipment before use of the present disposable cartridges.

The disposable cartridge of the present invention is packed with a non-swelling organoclay. Preferred organoclays in accordance with the present invention are formed by contacting certain types of aluminosilicate substrate materials (such as certain clays) with an alkylamine base. More specifically, they may be formed by combining a granular microporous non-swelling aluminosilicate substrate with a primary, secondary or tertiary alkylamine base. The main components can exist as a blend by nature of physical entrapment, adsorption, absorption, coating, and the like, or alternatively, could be bonded by covalent, ionic, hydrogen bonding, hydrophobic association, chelation, or other means. The subject organoclay compositions are more hydrophobic than their unmodified starting minerals by nature of their incorporation of the alkylamine base modifier. The organoclay compositions are also generally characterized by a higher capacity for absorbing hydrocarbons in the presence of water, as compared with the unmodified clay minerals.

The quaternary amine modified clays of the prior art are generally less hydrophobic than the organoclay compositions contemplated for use in the present invention and as a result they have a inferior capacity for absorbing hydrocarbons in the presence of water. This reduced capacity for absorbing hydrocarbons could be a result of water absorption into the quaternary amine modified clays. A further disadvantage of the quaternary amine modified clays is the reduced mechanical strength of the particles relative to the granular particles of the present compositions. Higher mechanical strength of the particles is desirable in applications such as purification of contaminated water streams, where the water has a tendency to soften and swell clay particles and cause breakage and clogging of equipment.

The presently contemplated organoclay compositions also can be made without the use of an acid halide as has been practiced in the prior art. The acid halide materials are hazardous and represent additional processing steps to achieve covalent binding of the modifier to the clay. The presently contemplated organoclays do not require activating reagents or covalent binding of the alkylamine base to the aluminosilicate mineral substrate.

The aluminosilicate substrate that is used to make the presently contemplated organoclays are microporous aluminosilicate minerals selected from the group consisting of attapulgite, sepiolite, palygorskite, Fuller's earth, zeolite, and hormite. As used herein, the alumninosilicate substrate alternatively may be referred to as a “clay”. An idealized formula representing attapulgite is (OH₂)₄(OH)₂Mg₅Si₈O₂₀-4H₂O and sepiolite is represented by Si₁₂Mg₉O₃₀(OH)₆(OH₂)₄-6H₂O, but natural variations occur in the mineral deposits. Attapulgite and sepiolite are clays of the hormite group, and palygorskite and Fuller's earth are synonyms for attapulgite. Based on this, any member of the hormite, attapulgite, Fuller's earth, sepiolite, or palygorskite mineral classifications that meets the criteria for the aluminosilicate substrate that are described herein can be used as the aluminosilicate substrate of the organoclays.

In another embodiment, a zeolite can be used as the aluminosilicate substrate of the organoclays. Zeolites are well known, from either synthetic or natural origin, and are characterized as crystalline microporous hydrated aluminosilicates having pores in the size range of 3-10 angstroms.

Attapulgite and sepiolite have a porous nature due to the needle-shaped crystal structure (which can also be described as “chain type” crystal structure). When an aluminosilicate substrate material of the present invention is described as being “microporous”, it is meant that the material has a Brunauer, Emmett, Teller (BET) surface area of at least about 100 m²/g and an average pore size of under about 10 angstroms. It is preferred that the substrate has a BET surface area of about 150-300 m²/g. The pores in the preferred attapulgite and sepiolite minerals have an average size of about 6 angstroms.

In an exemplary embodiment, the aluminosilicate substrate is microporous. This porosity provides an effective surface area greater than that of an equivalent particle size distribution of non-porous material, such as sand, glass dust, and the like. The combination of microporosity with a particle having a granular size has been found to be particularly advantageous.

The microporous aluminosilicates are characterized by a void volume of 10% to 70%, and preferably from about 30% to about 50%. The void volume can be defined as the volume percent capacity of the dried substrate to absorb a liquid without significant swelling. For example, a quantity of LVM attapulgite was found to absorb 50% of its volume in water without swelling more than 10%. When it is said that the present aluminosilicate substrates are non-swelling, it is meant that they exhibit swelling upon absorption of less than 20% by volume. It is preferred that the aluminosilicates swell less than 10% by volume.

The density of the porous aluminosilicate substrate is also an indicator of the extent of porosity. If completely non-porous, the density of a dried aluminosilicate would be in excess of 2,500 kg/m³. The dried aluminosilicates having a bulk density of 320 to about 2,400 kg/m³ are characterized as porous. It is preferred that the bulk density of the dried aluminosilicate substrates is from about 320 to about 1,000 kg/m³.

While the properties of the aluminosilicate that are described above are preferred to make the organoclay composition of the invention, it should be understood that the aluminosilicate might become somewhat less porous and more dense upon modification with the alkylamine base of the invention, and that the void volume would be decreased accordingly. The presence of moisture or solvents in the aluminosilicate would also have a similar effect.

When the aluminosilicate substrates are in hydrated form, the pores are filled with water molecules or hydrated cations that may be driven off by heating to 500° C. to produce a low volatile material (LVM) clay. Clays dried at 200° C. are referred to as regular volatile material (RVM) clays. While the organoclay compositions of the current invention may be prepared from hydrated, dried, calcined, LVM, or RVM clays, the preferred form is an RVM clay, and LVM clay is even more preferred.

Clays that are suitable for use in accordance with the present invention are preferably derived from a naturally occurring mineral source, but synthetic clays are expected to be effective as well. The clay is preferably provided in the form of a granular solid having a high surface area, but a finely divided clay, an agglomerated clay, or even a slurry of clay particles in a liquid would be sufficient. The preferred granular solid differs from support materials of the prior art in that in many known materials, large surface area was obtained by the provision of very fine particles, such as fines, silt, dust and sand. By way of comparison, a preferred particle size is granular, as described below, which allows for higher flow rates or a lower back pressure of liquid passing through a column, layer, or bed of the composition. This makes the present composition more suitable for commercial applications and continuous flow applications. Moreover, it is believed that handling of finely divided solids can have harmful effects upon humans, so that the present granular materials would also be safer than the very fine materials.

The aluminosilicate substrate and the organoclay composition are preferably granular materials, rather than fine materials. A majority of the particles of the substrate and the organoclay, by weight, are within the range of from about 0.1 mm to about 10 mm in diameter, and preferably from about 1 mm to about 3 mm. In some embodiments, the preferred size range is between about 0.6 and about 2.4 mm. The particle size of the aluminosilicate substrate can be characterized by retention on a standard mesh screen. When it is said that an aluminosilicate substrate is “granular”, it is meant that the material is composed of particles having a size range where 20%-100% by weight are retained on a #60 mesh screen and not over 20% by weight of the particles are over 4 mm. A preferred clay is characterized by 80%-100% by weight retention on a #60 mesh screen, more preferred is a clay characterized by 95%-100% by weight retention on a #60 mesh screen. Another preferred aluminosilicate substrate is one having particles characterized by retention of at least 50% by weight on a #30 mesh screen and not over 20% by weight of the particles are over about 2 mm.

Preferred aluminosilicate substrates are attapulgite, sepiolite, and zeolite. In particular, it is preferred that the aluminosilicate substrate contain at least 80% by weight of one of these materials. It is anticipated that substitution of another non-swelling, porous, aluminosilicate material having high surface area could be substituted for the preferred aluminosilicate substrates without departing from the scope of the invention. When the an aluminosilicate substrate is defined herein as a certain class of mineral, it is understood that the clay is predominantly composed of that mineral, but it would be expected that other minerals might also be present in minor amounts.

In a preferred embodiment, the clays of the invention are non-swelling clays, such that the volume of the clay particles does not increase significantly upon contact with liquids. The non-swelling clays typically have better physical integrity in an aqueous environment that swelling clays, such as bentonite (montmorillionite). Non-swelling clays have a higher particle hardness and better crush strength in the presence of water, resulting in better maintenance of the desired granular form of the particles.

The alkylamine base is characterized as a material that is selected from the group consisting of primary, secondary, and tertiary alkylamines. In a preferred embodiment, the alkylamine base has the chemical structure R¹R²R³N where at least one of the R groups is an alkyl group containing 6-30 carbon atoms and the other R groups can represent hydrogen atoms. It is more preferred that the alkyl group have from about 10 to 30 carbons and even more preferred that is has about 12 to 30 carbons. Alternatively, a preferred alkyl group is one that has at least about 12 carbons, or more. The preferred alkylamine base is characterized as being nonionic. It is also preferred that the alkylamine base is non-amphoteric. It is believed that incorporation of ionic functional groups onto the subject alkylamines would decrease the hydrophobicity of the resulting organoclay composition, thereby reducing a desirable property of the composition.

A preferred alkylamine base is a fatty alkylamine and more preferably the alkylamine base is a primary fatty alkylamine. A preferred alkylamine base is insoluble in water, and has not been chemically modified prior to contacting it with the aluminosilicate substrate.

Alkylamine bases that are useful in the present invention are oleyl amine, tallow amine, hydrogenated tallow amine, octylamine, dodecylamine, hexadecylamine, octadecylamine, N-tallowalkyl-1,3-diaminopropane, cocoalkylamine, dihydrogenated tallowalkylamine, trihexadecylamine, octadecyldimethylamine, dihydrogenated tallowalkylmethylamine, dioctadecylamine, and the like.

If desired, the alkylamine can be dissolved or dispersed in a solvent to provide adequate coverage of the clay mineral. For the purposes of this invention, the solvent is considered to be any liquid in which the alkylamine base can be dissolved or dispersed. In one embodiment, the alkylamine is dispersed in the solvent in the form of a heterogeneous emulsion or dispersion. In a preferred embodiment, the alkylamine is dissolved in a solvent to form a true homogeneous solution.

The solvent is typically selected from the group consisting of water, alcohols, halogenated solvents, glycols, ethers and combinations thereof. Useful solvents are isopropanol, water, dichloromethane, ethylene chloride and n-propylbromide.

When a solvent is used in the novel method, the solvent is used as a carrier to aid in contacting the alkylamine base with the clay mineral. After the contacting step, the solvent can be removed. It is preferred that the solvent is removed by evaporation or distillation. To facilitate removal of the solvent, a low-boiling solvent is preferred, with a boiling point of 120° C. or lower at 760 mm Hg pressure. In another embodiment, the solvent is removed at a reduced pressure relative to the ambient atmospheric condition.

In one embodiment, the solvent is removed until a residual content of less than 10% by weight of the organoclay remains. Preferably, the residual solvent content of the organoclay is less than 3%, and most preferably the residual solvent content is less than 1%.

Solubilizing agents can be added with the solvents to assist the function of dispersing or dissolving the alkylamine modifier. The solubilizing agents can be selected from surfactants, coupling agents, and cosolvents.

Methods of preparation of the subject composition include providing a vessel to contact the aluminosilicate substrate with the alkylamine base. Such vessels can include stirred vessels, rotating vessels, static vessels, ovens, kilns, dryers, and cartridges. The alkylamine base can be applied as a neat liquid or preferably as a solution, with the use of spray nozzles or bars or other suitable means to deliver a liquid into contact with a solid. Preferably, a means is provided to heat the treated clay to assist in removing the solvent and residual moisture. In one embodiment, the organoclay composition is dried at a temperature between 20 and 250 degrees Celsius. Preferably, the organoclay is dried at a temperature between 40 and 150 degrees Celsius, and most preferably the organoclay is dried at a temperature between 50 and 100 degrees Celsius.

In the case where nonaqueous solvents are used in making the organoclay composition, recycling of the solvent is preferred for economic and environmental reasons. In the embodiment where water is used as the solvent, the drying temperature is preferably between 100 and about 250 degrees Celsius.

It is preferred that the weight ratio of the alkylamine base to aluminosilicate substrate is between 0.01:1 and 2:1, more preferred is a ratio of alkylamine to aluminosilicate is between 0.05:1 and 1:1, and even more preferred is a ratio of alkylamine to aluminosilicate is between 0.1:1 and 0.6:1.

Useful aluminosilicate substrates include those that would be 20%-100% by weight retained on a #60 mesh screen. Preferably, the organoclay composition is characterized by 80%-100% retention on a #60 mesh screen, and more preferably, the organoclay composition is characterized by 95%-100% retention on a #60 mesh screen. Another preferred size range of the subject granular composition is that at least about 50% by weight of the material is retained on a #30 mesh screen.

The disposable cartridge of the present invention is preferably packed with the above described non-swelling organoclay. In an exemplary embodiment, the disposable cartridge is filled to a volume capacity of greater than about 85%, more preferably greater than about 90%, and most preferably greater than about 95% with the non-swelling organoclay.

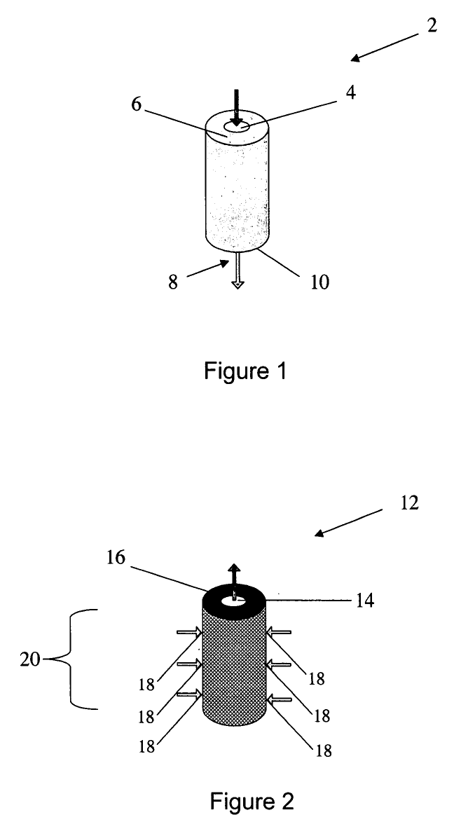

The flow direction of the aqueous stream through the present disposable cartridge may be radial or axial. As used herein, an axial flow cartridge 2, as depicted in FIG. 1, is a cartridge 2 wherein the aqueous stream enters the cartridge 2 through an inlet 4 located on one end cap 6 of the cartridge 2 and exits the cartridge 2 through at least one outlet 8 located on the opposite end cap 10 of the cartridge 2. Also as used herein, as depicted in FIG. 2, a radial flow cartridge 12 is a cartridge 12 wherein the aqueous stream exits the cartridge 12 through an outlet 14 located on an end cap 16 of the cartridge 12 and enters through one or more inlets 18 located on the side 20 of the cartridge 12.

In another aspect, the invention is a method for the removal of oil particles having a diameter of less than about 0.5 millimeter from an aqueous stream. The method includes providing a disposable cartridge, such as the disposable cartridge discussed above and including a packed bed of non-swelling organoclay, through which the oil-containing aqueous stream can be directed. The method further includes directing the oil-containing aqueous stream through the disposable cartridge and adsorbing, absorbing, chelating, coalescing, complexing, and/or associating the oil onto the non-swelling organoclay.

In one embodiment, the step of directing the oil-containing aqueous stream includes directing the aqueous stream in an axial direction through the disposable cartridge. In another embodiment, the step of directing the oil-containing aqueous stream includes directing the aqueous stream in a radial direction. In yet another embodiment, the step of directing the aqueous stream includes directing the aqueous stream in both a radial and axial direction through the disposable cartridge.

An axial flow design may be more preferred for use in the present invention. An axial flow design may lengthen the mass transfer zone, may prevent short-circuiting on the system, and may maximize the sorbent holding capacity by eliminating the annular space.

In an exemplary embodiment, the oil content of the aqueous stream exiting the cartridge is not over about 15 ppm, more preferably, not over about 10 ppm, and even more preferably not over about 5 ppm. In a particularly exemplary embodiment, the oil content of the aqueous stream exiting the cartridge meets the guidelines set forth by the MEPC bilgewater discharge regulations.

The method may further include the step of removing the disposable cartridge after the non-swelling organoclay is saturated and replacing the saturated disposable cartridge with a second disposable cartridge. In preferred embodiments, the second (and any subsequent) disposable cartridge will meet the above described characteristics of disposable cartridges in accordance with the present invention. The present disposable cartridges are particularly suited for use in the presently described method, because of their low weight and configuration to operate in standard housings. Accordingly, replacement of cartridges is straightforward and can be easily and quickly completed by a single person.

It may be desirable to use more than one disposable cartridge in accordance with the present invention. For example, multiple cartridges can be configured in series or parallel. The use of multiple cartridges would enable faster decontamination of an aqueous stream.

In some embodiments, a probe may be inserted into the disposable cartridge to determine the level of saturation of the non-swelling organoclay. Probes suitable for use in accordance with this embodiment of the invention are known to those having ordinary skill in the art. Such a probe would serve to notify an operator when the organoclay was saturated and would alert the operator that a changeout of the cartridge, as discussed above, would be necessary.

The present method may also include disposing of the saturated disposable cartridge by incineration. This step becomes particularly useful in accordance with a third aspect of the present invention. In a third aspect, the invention is a method for decontaminating bilgewater containing oil contaminants. This aspect is particularly useful in a shipboard environment.

As used herein, the term “ship” shall refer to any waterborne vessel, including, but not limited to, a ship, boat, barge, raft, and/or submarine. Similarly, as used herein, the term “shipboard” shall refer to the onboard environment of any waterborne vessel, including, but not limited to, ships, boats, barges, rafts, and/or submarines.

The method includes passing the contaminated bilgewater through a disposable cartridge packed with a non-swelling organoclay having a particle size range of between about 0.1 and about 10 mm, wherein the non-swelling organoclay absorbs, adsorbs, coalesces, chelates, complexes, and/or associates the contaminates in the bilgewater and the decontaminated bilgewater exits the disposable cartridge.

Disposable cartridges contemplated as useful in the present aspect of the invention are discussed above. The method may further include replacing a first disposable cartridge with a second (and subsequent) disposable cartridge after the non-swelling clay in the first disposable cartridge has become saturated with contaminants from the bilgewater.

The method may further include incinerating a saturated cartridge. Those having ordinary skill in the art will recognize that space on a ship is a valuable commodity. Current cartridges useful for decontaminating bilgewater require storage of the saturated cartridges until the ship reaches a port, where the saturated cartridges may be disposed. The present method allows the presently described saturated cartridges to be incinerated after use, resulting in only a clay ash residue. This method frees space on board for additional cargo or other uses. Shipboard incinerators are typically utilized for general waste disposal. Accordingly, saturated disposable cartridges in accordance with the present invention may be easily and economically disposed of onboard the ship without requiring long-term storage.

In an exemplary embodiment, the method may include passing the aqueous stream through the disposable cartridge in a gravity-fed flow. Alternatively, the aqueous stream may be passed through the disposable cartridge in a pressure-driven flow. In yet another embodiment, the aqueous stream may be passed through the disposable cartridge with a combination of a gravity-fed and pressure-driven flow.

The present apparatus and methods are beneficial in a variety of environments, including a shipboard environment. The containment of the organoclay in a disposable cartridge avoids worker exposure to the potentially hazardous oil contaminants in and on the organoclay. Additionally, incineration is a viable disposal option for the organoclay after use. In applications such as bilgewater treatment, shipboard incinerators are used for general waste disposal and may be readily utilized for disposal of saturated cartridges.

The small filter sizes, as discussed above, render cartridge changeouts relatively easy. The small, manageable size of the disposable cartridge eliminates the need for cranes, hoists, and/or winches during maintenance, and servicing can be done by a singe worker. Additionally, the cartridge design occupies a small footprint, as required on boats, barges, and ships.

Those having ordinary skill in the art will recognize that a shipboard environment is not conducive to the use of bulk media or difficult changeouts for saturated cartridges. For example, in a shipboard environment, deck space is at a premium and equipment footprints must be small. Watertight doors, bulkheads, and generally cramped quarters make the movement of equipment below decks difficult. Additionally, with the complexity of a “floating city,” engineers and maintenance personnel resources are stretched thin in a shipboard environment. Ease of media changeout is, therefore, especially important in this environment. The ability of the present cartridges to be incinerated is also beneficial in a shipboard environment, due to the ease of incineration and the alleviation of need for storage space. Those having ordinary skill in the art will recognize, therefore, that the small, lightweight, and compact size of the present cartridges renders them especially beneficial in a shipboard environment.

The cartridges of the present invention can be filled to greater than 85% of the volume capacity with organoclay because the preferred organoclay does not swell in water. The previously available cartridges were a radial flow design and were only filled to about 75% by volume with organoclay to allow for swelling/expansion of the organoclay. The extra space was required to prevent backpressure and flow limitations caused by swelling and plugging. The present design, especially the axial design, prevents short-circuiting of flow around the organoclay.

Additionally, previously available sorbent cartridge baskets were fabricated from stainless steel and were refillable, not disposable. Accordingly, additional man hours were required to empty, clean, and refill the cartridges. The present invention, as discussed above, reduces the time and equipment necessary for changeouts, thereby increasing efficiency.

The present cartridges are preferably compatible with standardized, commercially available bag filter housings, avoiding the expense and delays associated with custom designed equipment.

Moreover, the disposable cartridges may be used to replace the use of loose bulk organoclay in flow through treatment filters. Typical installations with bulk organoclay require the use of a vacuum truck to extract the spent organoclay, followed by cleaning and pumping in a fresh charge of organoclay. This may typically be done only when a ship is in port. The present apparatus and methods allow replacement of spent organoclay away from port.

Other embodiments within the scope of the specification and claims herein will be apparent to one skilled in the art from consideration of the specification or practice of the invention as disclosed herein. It is intended that the specification be considered to be exemplary only, with the scope and spirit of the invention being indicated by the claims.

All references cited in this specification, including without limitation, all papers, publications, patents, patent applications, presentations, texts, reports, manuscripts, brochures, books, internet postings, journal articles, periodicals, and the like, are hereby incorporated by reference into this specification in their entireties.

The discussion of the references herein is intended merely to summarize the assertions made by their authors and no admission is made that any reference constitutes prior art. Applicants reserve the right to challenge the accuracy and pertinency of the cited references.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged both in whole or in part.

What is claimed is:

1. A method for the removal of contaminant particles having a diameter of less than about 0.5 millimeter and/or dissolved contaminants from an aqueous stream, the method comprising:
providing a disposable cartridge through which the contaminant-containing aqueous stream can be directed, wherein the cartridge comprises a packed bed of non-swelling organoclay; and
directing the contaminant-containing aqueous stream through the disposable cartridge; and
adsorbing, absorbing, chelating, coalescing, complexing, and/or associating the oil onto the non-swelling organoclay.

2. The method according to claim 1, wherein the contaminant particles are one or more of oil, grease, hydrocarbons, pesticides, heavy metals, radioactive waste, colored materials, odor-causing materials, suspended solids, turbidity, haze, paint, solvents, resins, condensate, industrial effluent, deinking waste, surfactants, emulsified materials, microorganisms, MTBE, BTEX, BOD, and COD.

3. The method according to claim 1, wherein the non-swelling organoclay comprises a granular microporous non-swelling aluminosilicate substrate comprising particles having a size distribution resulting in 20%-100% by weight retention on a #60 mesh screen having absorbed thereon a primary, secondary, or retention alkylamine base.

4. The method according to claim 1, wherein the aqueous stream can be directed through the disposable cartridge in an axial direction.

5. The method according to claim 1, wherein the aqueous stream can be directed through the disposable cartridge in a radial direction.

6. The method according to claim 1, wherein the cartridge is substantially cylindrical

7. The method according to claim 1, wherein the cartridge weighs between about 30 and 50 pounds when packed with the non-swelling organoclay.

8. The method according to claim 1, wherein the cartridge may be filled with the non-swelling organoclay to a volume capacity of greater than about 85%.

9. The method according to claim 1, wherein the cartridge comprises a plastic construction capable of being incinerated.

10. The method according to claim 1, wherein the contaminant content of the aqueous stream exiting the cartridge is not over about 15 ppm.

11. The method according to claim 1, wherein the contaminant content of the aqueous stream exiting the cartridge is not over about 10 ppm.

12. The method according to claim 1, wherein the contaminant content of the aqueous stream exiting the cartridge is not over about 5 ppm.

13. The method according to claim 1 further comprising the step of incinerating the cartridge after the cartridge has become saturated with contaminant particles.

14. The method according to claim 1, further comprising replacing a saturated cartridge with a new disposable cartridge.

15. The method according to claim 1, wherein the disposable cartridge is between about 8 and about 72 inches in length.

16. The method according to claim 1, wherein the disposable cartridge is between about 2 and about 12 inches in diameter.

17. The method according to claim 1, wherein the disposable cartridge is sized for use in commonly available filter housings.

18. The method according to claim 1, wherein the disposable cartridge is sized for use in a #2 bag filter housing.

19. A disposable cartridge for the removal of contaminant particles having a diameter of less than about 0.5 millimeter and/or dissolved contaminants from an aqueous stream, the cartridge comprising:
a substantially cylindrical chamber that is filled with a non-swelling organoclay;
end fittings designed for removable insertion into a flow channel carrying the aqueous stream and which direct the flow of the aqueous stream through the cartridge.

20. The disposable cartridge according to claim 19, wherein the substantially cylindrical chamber is constructed of a plastic material suitable for incineration.

21. The disposable cartridge according to claim 19, wherein the cartridge is sized for use in commonly available filter housings.

22. The disposable cartridge according to claim 19, wherein the cartridge is between about 8 and about 72 inches in length.

23. The disposable cartridge according to claim 19, wherein the cartridge has a diameter between about 2 and about 12 inches.

24. The disposable cartridge according to claim 19, wherein the cartridge is sized for use in a #2 bag filter housing.

25. The disposable cartridge according to claim 19, wherein the cartridge is filled to a volume capacity of greater than about 85% with the non-swelling organoclay.

26. The disposable cartridge according to claim 19, wherein the non-swelling organoclay comprises a granular microporous non-swelling aluminosilicate substrate comprising particles having a size distribution resulting in 20-100% by weight retention on a #60 mesh screen having absorbed thereon a primary, secondary, or retention alkylamine base.

27. The disposable cartridge according to claim 19, wherein the direction of flow through the cartridge is axial.

28. The disposable cartridge according to claim 19, wherein the direction of flow through the cartridge is radial.

29. The disposable cartridge according to claim 19, wherein the packed cartridge weighs between about 30 and about 50 pounds.

30. The disposable cartridge according to claim 19, wherein the non-swelling organoclay is capable of adsorbing, absorbing, chelating, coalescing, complexing, and/or associating contaminant particles.

31. A method for decontaminating bilgewater containing contaminant particles, the method comprising:
passing the contaminated bilgewater through a disposable cartridge packed with a non-swelling organoclay having a particle size range of between about 0.1 and about 10 mm;
wherein the non-swelling organoclay absorbs, adsorbs, coalesces, chelates, complexes, and/or associates contaminants in the bilgewater and the decontaminated bilgewater exits the disposable cartridge.

32. The method according to claim 31, wherein the method further includes the step of replacing a cartridge after the non-swelling organoclay is saturated with contaminants with a second disposable cartridge.

33. The method according to claim 31, wherein the method further includes the step of incinerating the cartridge after the non-swelling organoclay is saturated with contaminants.

34. The method according to claim 31, wherein the disposable cartridge is constructed of plastic materials capable of being incinerated.

35. The method according to claim 31, wherein the non-swelling organoclay comprises a non-swelling aluminosilicate substrate comprising particles having a size distribution resulting in 20% to 100% by weight retention on a #60 mesh screen having absorbed thereon a primary, secondary, or retention alkylamine base.

36. The method according to claim 31, wherein the step of passing the bilgewater through the disposable cartridge comprises passing the bilgewater in an axial flow pattern.

37. The method according to claim 31, wherein the step of passing the bilgewater through the disposable cartridge comprises passing the bilgewater in a radial flow pattern.

38. The method according to claim 31, wherein the step of passing the bilgewater through the disposable cartridge comprises a gravity-fed flow.

39. The method according to claim 31, wherein the step of passing the bilgewater through the disposable cartridge comprises a pressure-driven flow.

40. The method according to claim 31, wherein the method further includes inserting a probe into the disposable cartridge to determine the saturation level of the non-swelling organoclay.
